(19) United States
(12) Patent Application Publication
(10) Pub. No.: US 2007/0203637 A1
(43) Pub. Date: Aug. 30, 2007

(54) System and method for identifying operational usage of fleet vehicles related to accident prevention

(76) Inventors: Jon Passman, Minnetonka, MN (US); Stephen Tenzer, Prior Lake, MN (US); Benjamin J. Nielsen, Lakeville, MN (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/337,412

(22) Filed: Jan. 23, 2006

(51) Int. Cl. G08G 1/00; G06F 19/00

(52) U.S. Cl. 701/117

(57) ABSTRACT

A system and method of identifying the occurrence of modifiable use conditions related to the safe use of fleet vehicles is described. Modifiable use conditions, such as the speed at which the vehicle is drive, tailgating and an excessive number of lane changes, represent opportunities to reduce unsafe uses of the vehicle. Modifiable use conditions are identified and the occurrence of such use conditions is determined. A user-defined statistical metric for the fleet, or a portion of the fleet, can be determined for each of the modifiable use conditions evaluated. The occurrence of modifiable use conditions related to safety of an individual vehicle, or a group of vehicles, can be compared with a larger group of vehicle, or the fleet, to determine vehicles which correspond to a metric of the fleet. Fleet managers can use this information to modify the use conditions of individual or group of vehicles to provide fuel savings for the fleet.

### FIELD OF THE INVENTION

This invention relates to a system and method for identifying operational usage of fleet vehicles related to accident prevention by monitoring and analyzing modifiable use conditions of vehicles individually or within the fleet.

### BACKGROUND OF THE INVENTION

Companies that use fleets of vehicles are subject to unsafe use of their fleet vehicles. For example, it is likely that some vehicles in a fleet will be driven at speeds in excess of a posted speed limit or a safe speed. Other vehicles will be driven in a manner where excessive braking is used, which may be the result of driving too closely behind the vehicle in front. Other operating conditions, such as rapid acceleration of the vehicle and large number of lane changes can increase the chance of an accident. Driving a vehicle when the tire pressure is outside a set range can influence the safe operation of a vehicle. Additionally, compliance with relevant standards for the number of hours an operator can use a vehicle over a set time can reduce unsafe operating conditions.

General concepts of how to modify operating conditions in individual vehicles to reduce accidents are widely known. For example, the U.S. Department of Transportation (USDOT) and the National Highway Traffic Safety Administration hosts websites www.dot.gov and www.nhtsa.gov that provides information on the safe operation of personnel and commercial vehicles.

The unsafe use of vehicles can result in increased numbers of accidents, resulting in increased operating costs. One way to reduce this problem is to identify use conditions of vehicles in the fleet that can be modified to reduce the potential for accidents.

Accordingly, there is a need for a system and method of identifying the occurrence of modifiable use conditions of vehicles in a fleet that can be modified to minimize the potential for accidents.

### SUMMARY OF THE INVENTION

Accordingly, the present invention is directed to a system and method of using information on the operation of individual vehicles within a fleet to identify the occurrence of modifiable use conditions of vehicles that can be modified to minimize the potential for accidents. This system and method substantially obviates one or more of the problems due to limitations and disadvantages of the related art.

An object of the present invention is to provide a system and method of identifying and modifying use conditions of vehicles to reduce the potential for accidents, thereby providing a cost savings opportunity for the fleet. An object of the present invention is to provide a system and method of analyzing an individual vehicle to identify the occurrence of modifiable use conditions related to unsafe operating practices of the vehicle. Another object of the present invention is to provide a system and method of identifying the occurrence of modifiable use conditions related to unsafe operating practices of the fleet.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system and methods are provided that identify the occurrence of modifiable use conditions related to unsafe operating practices of the vehicles. Methods are also provided for identifying changes in the occurrence of modifiable use conditions related to unsafe operating practices of the vehicles over time.

It is to be understood that both the foregoing general description and the following detailed description are exemplary and explanatory and are intended to provide further explanation of the invention as claimed.

### DESCRIPTION OF DRAWINGS

FIG. 1 is a block diagram representation of a system for identifying the occurrence of modifiable use conditions related to unsafe operating practices in a fleet of vehicles in an embodiment of the present invention.

FIG. 2 is a schematic representation of the steps in a method of identifying the occurrence of modifiable use conditions related to unsafe operating practices in a fleet of vehicles using an embodiment of the present invention.

### DETAILED DESCRIPTION OF THE PREFERRED EMBODIMENTS

Reference will now be made in detail to an embodiment of the present invention, example of which is illustrated in the accompanying drawings.

The term fleet can encompass a plurality of vehicles owned, or used, by a common entity. The term can encompass a plurality (but not all) of vehicles in the fleet, or all of the vehicles in the fleet. For example, vehicles within a fleet may be divided into geographical regions. The use of the terms fleet can encompass a collection of vehicles within a region.

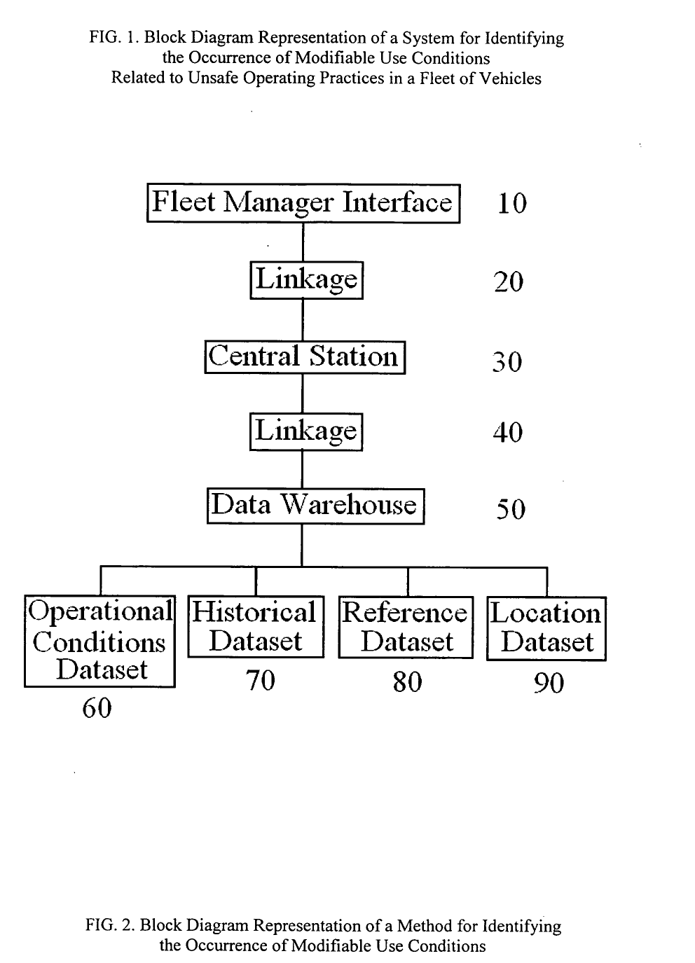

FIG. 1 illustrates a block diagram of a representative system for identifying criteria that leads to accidents in a fleet of vehicles. The system comprises a fleet manager interface 10 with linkage 20 to central station 30 which contains, or is linked through linkage 40 to, data warehouse 50. Data warehouse 50 comprises at least one operational conditions dataset 60 and at least one positional dataset 90 for fleet vehicles 90. The data warehouse may further comprise historical datasets 70, reference datasets 80, and other information related to the fleet.

Fleet manager interface 10 represents a desktop computer, a laptop computer, workstation, handheld device, or other such device for interacting with a central station 30. Linkage 20 between fleet manager interface 10 and central station 30 may be through a communications network (which may a wired or wireless LAN, WAN, internet, extranet, peer-to-peer network, cellular or satellite transmission network), or through other such devices that allow for the transmission of information between the fleet manager interface and the central station. Central station 30 may comprise a single computer/workstation, multiples computers/workstations, servers, routers, storage devices, and combinations thereof, and associated software. Linkage 40 between central station 30 and data warehouse 50 may be through a communications network (which may a wired or wireless LAN, WAN, internet, extranet, peer-to-peer network, cellular or satellite transmission network), or through other such devices that allow for the transmission of information between the central station and the data warehouse. Calculations can be performed by any computer, server or process within central station 30 and data warehouse 50.

Data warehouse 50 comprises at least one server, storage medium or combination thereof. These devices may be located at one, or multiple facilities and may be directly linked or linked through a network. Data warehouse 50 comprises datasets, or databases, of information that describes the operational conditions 60 of individual vehicles during daily activities and may include at least one dataset describing operational characteristics of the fleet, or portions of the fleet. Operational data on individual vehicles may be processed data based on raw data from sensors on a vehicle, or calculated data derived from either raw or processed data. Examples of operational data may include, but is not limited to, vehicle speed, tire pressure, and following distance behind a vehicle ahead.

Data warehouse 50 may contain historical datasets 70 based on previously available data on individual vehicles, portions of the fleet, or the entire fleet. The historical data may describe the operational conditions of individual vehicles, portions of the fleet or the entire fleet during daily activities and may include at least one dataset describing operational characteristics of the fleet, or portions of the fleet.

Data warehouse 50 may contain at least one reference dataset 80 comprising information related to safe operating conditions for vehicles. Examples of such reference data include, but are not limited to: safe following distances at different speeds, or allowable work times. The information may include information from secondary sources, such as the USDOT web site, vehicle manufacturers, and research papers and any other secondary source containing information on safe use conditions for vehicles.

Data warehouse 50 comprises at least one positional dataset 90, that comprises information on the geographical location of vehicles within the fleet over time. The geographical location can be obtained by a variety of methods, including a locator that uses a position determining system, such as the Global Positioning System (GPS), Differential GPS (DGPS), Eurofix DGPS, and the Global Navigation Satellite System (GLONASS). Importantly, the present invention is well-suited to use any position determining system (both terrestrial and satellite based) as well as future systems that may be developed, and is not dependent on the use of a particular system.

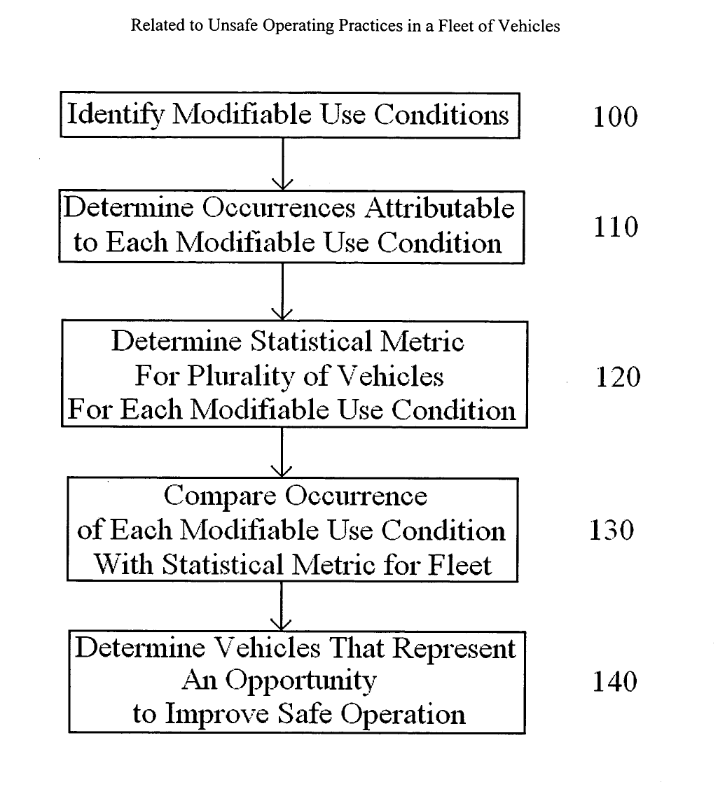

FIG. 2 is a block diagram representation of a method for identifying opportunity to improve the safe operation of a fleet of vehicles by modifying use conditions. Modifiable use conditions are identified 100. Modifiable use conditions are operational conditions of the vehicle that are related to safety and, when modified, have the potential to reduce accidents. Examples of modifiable use conditions include, but are not limited to: driving a vehicle at a speed exceeding a defined speed, rapidly switching between acceleration and braking in a vehicle, accelerating the vehicle, changing lanes with the vehicle, driving the vehicle a set distance behind the vehicle ahead of it, driving the vehicle with tire pressure outside a set range, driving the vehicle with excess weight, and driving a vehicle when the number of driver hours exceeds an established value over a set time period.

After modifiable use conditions are identified 100, the occurrence of each modifiable use condition is determined 110. The large number and variety of sensors either currently in use, or in development, allows for a wide variety of safety related use conditions to be monitored. For example, the speed of a vehicle can be determined, or calculated, using a variety of sensors on a vehicle which may make measurements of distance traveled and time. Accelerometers on the vehicle can measure changes in speed as well as lane changes. Sensors can monitor the distance between a vehicle and objects, such as other vehicles, in front of it. Tire pressure can be monitored to determine when the pressure of a tire is outside a set range, while weight sensors can determine the weight a vehicle is carrying. A variety of methods are available to track an operator and control settings on a vehicle based on the operator. For example, computers within the vehicle can keep track of the number of hours each user has driven the vehicle.

A user-defined statistical metric for a plurality of vehicles for the occurrence of each modifiable use condition can be determined 120. Methods of generating user-defined statistical metrics are well known to one skilled in the art. Examples of user-defined statistical metrics concerning the modifiable use condition of speeding can include, but are not limited to, mean, median, upper 90^{th} percentile, upper 95th percentile, and statistically significant outliers.

Comparing 130 the value for a modifiable use condition on each vehicle to the selected user-defined statistical metric for the same modifiable use condition from the fleet identifies 140 vehicles representing an opportunity to improve safe use conditions fleet-wide.

In an embodiment, the occurrence of at least one modifiable use condition for each vehicle can be evaluated over time 160. In another embodiment, the occurrence of each modifiable use condition for a plurality of fleet vehicles can be evaluated over time 170.

Use conditions in a vehicle may be adjusted 190 using a variety of methods as appropriate to reduce the occurrence of safety related modifiable use conditions. Methods of modifying use conditions on a vehicle can be applied to individual vehicles or groups of vehicles. Examples of such methods include, but are not limited to: driving a vehicle at a speed below a defined speed, avoiding rapid acceleration or deceleration of the vehicle, avoiding frequent lane changes, driving the vehicle a set distance behind the vehicle ahead of it, driving the vehicle with tire pressure within a set range, driving the vehicle under a set weight limit, and driving a vehicle when the number of driver hours is below an established value over a set time period.

Use conditions for the fleet of vehicles (as opposed for a single vehicle) may be adjusted 200 using a variety of methods. Examples of such methods include, but are not limited to: changing fleet operating procedures to require vehicle operators to check and maintain tire pressure within a set range, and changing operator assignments to adjust scheduled driving times of operators to be under set hours.

Examples of identifying the occurrence of unsafe operating practices of the vehicles within the fleet from identifying modifiable use conditions are given below. These examples are not exhaustive and are meant to demonstrate embodiments of the invention. Other modifiable use conditions can be encompassed.

### EXAMPLE 1

### Driving a Vehicle at a Speed Exceeding a Defined Speed

Data warehouse 50 contains an operational conditions dataset 60 on all of the vehicles of the fleet. Contained within that dataset is the speed of each vehicle over time. Fleet management determines a defined speed against which comparisons of the vehicles speed are made. For example, fleet management sets a defined speed of 65 miles per hour (mph), the maximum speed limit within the travel area of its vehicles. The user-defined statistical metric to be used is all occurrences over the defined speed. For each vehicle, the number of times when the 65 mph limit is exceeded are determined. In an embodiment, the maximum speed of the vehicle is determined. In another embodiment, the amount of time each vehicle exceeds the defined speed is determined. In a further embodiment, the amount of time each vehicle exceeds the defined speed in defined blocks of speed, such as 5 mph increments. For example, if the defined speed is 65 mph, the amount of time the vehicle travels at 65-70 mph, 70-75 mph, 75-80 mph, etc. is determined. The time period over which the vehicle exceeds the defined speed is determined from this dataset. This procedure determines the speeding behavior on an individual basis. This calculation may be performed over a number of time periods including, but not limited to days, weeks, months or years.

### EXAMPLE 2

### Frequency of Applying Brakes on the Vehicle

Data warehouse 50 contains an operational conditions dataset 60 on all of the vehicles of the fleet. Contained within that dataset is information on braking of the vehicle. Such information can be obtained by a variety of systems, such as that produced by Acculeon. In an embodiment, the number of times brakes are applied over a set period of time is evaluated. In another embodiment, the frequency that a driver changes from acceleration to braking is evaluated. This procedure can determine aggressive driving or following too closely possibly indicating a safety issue on an individual basis. This calculation may be performed over a number of time periods including, but not limited to days, weeks, months or years.

In an embodiment, a user-defined statistical metric for the fleet is determined based on the number of times brakes on a vehicle are applied over a set time. For example a user-defined statistical metric may be set at 4 braking events per minute. In that case, all vehicles which brake more than 20 times in a minute are identified. In another embodiment, a user-defined statistical metric for the fleet is determined based on the upper 90^{th} percentile of the number of breaking events per minute by individual vehicle.

In an embodiment, use conditions of individual vehicles can be adjusted by identifying individual vehicles having braking events greater than the fleet metric and make operators aware of the potential to minimize accidents by operating the vehicle in a manner that less braking is require, for example less tailgating. In another embodiment, the operational characteristics of individual vehicles identified as having braking events greater than the fleet metric can be examined to determine if braking occurrences changed after vehicles were identified and operators were made aware of the potential to minimize accidents by operating the vehicle in a manner that less braking is required.

### EXAMPLE 3

### Frequency of Rapid Acceleration or Deceleration of the Vehicle

Data warehouse 50 contains an operational conditions dataset 60 on all of the vehicles of the fleet. Information on acceleration and deceleration of the vehicle may be contained that dataset. A fleet manager can set a rate of acceleration to a value indicative of a “jack-rabbit” start. The fleet manager can set a rate of deceleration to a value indicative of “hard-breaking”. In an embodiment, the number of times the vehicle accelerates over a set rate over a set period of time is evaluated. In another embodiment, the maximum acceleration of the vehicle is evaluated. In an embodiment, the number of times the vehicle decelerates over a set rate over a set period of time is evaluated. In another embodiment, the maximum deceleration of the vehicle is evaluated. In another embodiment, the number of times the vehicle accelerates over a set rate and the number of times the vehicle decelerates over a set rate over a set period of time is evaluated. This procedure determines unsafe vehicle use on an individual basis. This calculation may be performed over a number of time periods including, but not limited to days, weeks, months or years.

In an embodiment, a user-defined statistical metric for the fleet is determined based on the number of times the vehicle accelerates over a set rate over a set period of time. For example a user-defined statistical metric may be set at one acceleration event per hour greater than 1.10 G's (force of gravity). In that case, all vehicles which accelerated at a rate of greater than 1.10 G's are identified. In another embodiment, a user-defined statistical metric for the fleet is determined based on the upper 90^{th} percentile of the number of accelerating events that exceed a set rate by individual vehicle.

In an embodiment, use conditions of individual vehicles can be adjusted by identifying individual vehicles having acceleration events greater than the fleet metric and make operators aware of the potential to minimize accidents by operating the vehicle in a manner that uses less acceleration. In another embodiment, the operational characteristics of individual vehicles identified as having acceleration events greater than the fleet metric can be examined to determine if acceleration occurrences changed after vehicles were identified and operators were made aware of the potential to minimize accidents by operating the vehicle in a manner where less acceleration is required.

### EXAMPLE 4

### Frequency of Lane Changes by the Vehicle

Data warehouse 50 contains an operational conditions dataset 60 on all of the vehicles of the fleet. Contained within that dataset is information on lane changes by the vehicle. This information may be derived from a variety of methods including information from an accelerometer and use of directional signals. In an embodiment, the number of times the vehicle changes lanes over a set rate over a set period of time is evaluated. This procedure determines unsafe aggressive lane changes for vehicles on an individual basis. This calculation may be performed over a number of time periods including, but not limited to days, weeks, months or years.

In an embodiment, a user-defined statistical metric for the fleet is determined based on the number of times the vehicle changes lanes over a set period of time. For example a user-defined statistical metric may be set at 4 lane changes per minute. In that case, all vehicles which changed lanes greater than 4 times a minute are identified. In another embodiment, a user-defined statistical metric for the fleet is determined based on the upper 90^{th} percentile of the number of lane changes by individual vehicles.

In an embodiment, use conditions of individual vehicles can be adjusted by identifying individual vehicles which change lanes greater than the fleet metric and make operators aware of the potential to minimize accidents by operating the vehicle in a manner where there are fewer lane changes. In another embodiment, the operational characteristics of individual vehicles identified as changing lanes greater than the fleet metric can be examined to determine if the number of occurrences changed after vehicles were identified and operators were made aware of the potential to minimize accidents by operating the vehicle in a manner where less frequent lane changes occur.

### EXAMPLE 5

### Driving a Vehicle Within a Set Distance of a Vehicle Ahead of It

Data warehouse 50 contains an operational conditions dataset 60 containing incidents of warnings of when the vehicle was within a set distance of a vehicle ahead of it. Such warnings may be based from measurements from a variety of sensors, such as proximity sensors. In an embodiment, the set distance is dependent upon the speed of the vehicle. In an embodiment, the number of warnings is determined over a set period of time. This determination may be performed over a number of time periods including, but not limited to days, weeks, months or years.

In an embodiment, a user-defined statistical metric is determined for the fleet based on the number of warnings obtained for individual vehicles. In an embodiment, the metric of zero warnings is set. Using this metric, all vehicles that were issued a warning are identified.

In an embodiment, operators of individual vehicles identified as having warnings can be made aware of the potential to minimize accidents by operating the vehicle in a manner where the vehicle is operated a further distance from the vehicle ahead of it, resulting in fewer alerts.

### EXAMPLE 6

### Driving a Vehicle with Tire Pressure Outside a Defined Range

Data warehouse 50 contains an operational conditions dataset 60 on all of the vehicles of the fleet. Contained within that dataset is information on tire pressure and miles driven for each vehicle over time. In an embodiment, information in the dataset comprises the pressure of each tire on the vehicle. In another embodiment, information in the dataset comprises a metric based on the pressure in the tires. In a further embodiment, information in the database comprises an indicator, such as yes or no, of the pressure in the vehicles tires being outside a set range.

In an embodiment, vehicles are selected if their tire pressure was outside a set range. In another embodiment, for each vehicle in the fleet the number of miles traveled by the vehicle while the pressure in its tires was outside a defined range is determined over a set period of time. This determination may be performed over a number of time periods including, but not limited to days, weeks, months or years. In an embodiment, a user-defined statistical metric is determined for the fleet based on the number of miles vehicles within the fleet were driven while tire pressure of the vehicle was outside a defined range. For example, if the user-defined statistical metric is any miles driven with tires pressure outside a defined range, all vehicles that drove any mileage with tire pressure outside the set range would be identified. In another embodiment, the mean number of miles vehicles within the fleet were driven while tire pressure of the vehicle was outside a defined range is determined. Vehicles driven with mileage in excess of that value are identified. This determination may be performed over a number of time periods including, but not limited to days, weeks, months or years.

In an embodiment, operators of individual vehicles identified as being driven while tire pressure is outside a set range can be made aware of the potential fuel savings. In another embodiment, the fleet manager may modify the amount of time vehicles within a fleet can drive on tires where the pressure is outside a determined range by requiring vehicle operators to check and, if necessary, adjust the vehicles tire pressure on a set basis.

### EXAMPLE 7

### Driving the Vehicle with Excess Weight

Data warehouse 50 contains an operational conditions dataset 60 on all of the vehicles of the fleet. Contained within the operational conditions dataset 60 is information on the weight of each vehicle and the distance traveled over time. Based on the type of vehicle and its intended usage, set weights for each vehicle may be determined. Vehicle driven with weights in excess of set weights can be identified and the occurrence of such conditions and number of miles driven under that condition can be determined. This procedure determines unsafe use of a vehicle based on weight on an individual basis. The number of occurrences and the number of miles driven on a fleet basis can be determined. This calculation may be performed over a number of time periods including, but not limited to days, weeks, months or years.

In an embodiment, a user-defined statistical metric is determined for the fleet based on the number of times a vehicle is driven in excess of a set weight. In another embodiment, the metric of zero miles driven while the vehicle carries weight above a set value is used. Using this metric, all vehicles driven carrying weight above a set value are identified. In another embodiment, the total number of miles driven by the identified vehicles is determined.

In an embodiment, individual vehicles identified as carrying excess weight can be made aware of the potential to improve safe operation. In another embodiment, the operational characteristics of individual vehicles identified as carrying excess weight greater than the fleet metric can be examined to determine if carrying excess weight has changed and a reduction in unsafe operating conditions have occurred. In an embodiment, the fleet manager may modify an allowable amount of weight that each vehicle in the fleet is allowed to carry.

### EXAMPLE 8

### Driving the Vehicle when the Operator Exceeds a Set Number of Driving Hours in a Given Period of Times

Data warehouse 50 contains an operational conditions dataset 60 on all of the vehicles of the fleet and at least one historical dataset 70 comprises information related to operator hours. Dataset 60 or 70 may include DOT logs or other information related to legal compliance issues. Operational conditions dataset 60 comprises information on the operator of each vehicle each time the vehicle is used. The number of times a vehicle is driven by an operator having driven in excess of a set number of hours can be determined. The amount of time a vehicle is driven by an operator having driven in excess of a set number of hours can also be determined. This calculation may be performed over a number of time periods including, but not limited to days, weeks, months or years.

In an embodiment, a user-defined statistical metric is determined for the fleet based on the number of times a vehicle is driven by an operator who exceeds a set number of driving hours in a given period of time for each vehicle within the fleet. In another embodiment, the metric of zero occurrences is set for a vehicle being driven by an operator who exceeds a set number of driving hours in a given period of times. Using this metric, all vehicles driven by an operator who exceeds a set number of driving hours in a given period of time are identified. In another embodiment, the total number of miles driven by the identified vehicles is determined.

In an embodiment, operators identified as having driven vehicles when they exceeded a set number of driving hours in a given period of time can be made aware of the potential to minimize accidents by not operating the vehicle under those conditions. In an embodiment, the fleet manager may modify the operating schedule of the vehicle to allow vehicles to be driven by operators who will not exceed a set number of driving hours in a given period of time.

It is to be understood that the present invention is not limited to the embodiments described above, but encompasses any and all embodiments within the scope of the following claims.

While the drawings and specific examples given describe exemplary embodiments of the present invention, they serve the purpose of illustration only. For example, the specific configuration of the diagnostic system and communication arrangement may differ depending on the work vehicle or platform or the mode of communication being used. The apparatus of the invention is not limited to the precise details and conditions disclosed. Furthermore, other substitutions, modifications, changes, and omissions may be made in the design, operating conditions, and arrangement of the preferred embodiments without departing from the spirit of the invention as expressed in the appended claims. A number of implementations have been described. Nevertheless, it will be understood that various modifications may be made. Accordingly, other implementations are within the scope of the following claims.

What is claimed is:

1. A method of identifying opportunity to reduce the potential for accidents in a fleet of vehicles comprising:
identifying a plurality of modifiable use conditions that represent an opportunity for accident prevention;
determining the occurrence of events attributable to each of a plurality of modifiable use conditions for a plurality of fleet vehicles;
determining, for each of the plurality of modifiable use conditions, a user-defined statistical metric relating to the occurrence of the events for a plurality of vehicles within the fleet that is attributable to each modifiable use condition; and
determining which vehicles within a fleet represent an accident prevention opportunity by comparing, for each of the vehicles within the fleet, the occurrence of events attributable to each vehicle for each of the plurality of modifiable use conditions with the user-defined statistical metric relating to the occurrence of events of a plurality of vehicles within the fleet that is attributable to each modifiable use condition.

2. The method of claim 1, wherein said plurality of modifiable use conditions comprise driving a vehicle at a speed exceeding a defined speed, applying the brakes on the vehicle, accelerating the vehicle in a sudden, rapid manner, decelerating the vehicle in a sudden, rapid manner, changing lanes with the vehicle, driving the vehicle a set distance behind the vehicle ahead of it, driving the vehicle with tire pressure outside a set range, driving the vehicle with excess weight, and driving a vehicle when the number of driver hours exceeds an established value over a set time period.

3. The method of claim 2, wherein determining the occurrence of events attributable to the modifiable use condition of exceeding a defined speed comprises determining the number of times the speed of the vehicle exceeds a set value over a time period.

4. The method of claim 3, wherein determining the number of times the speed of the vehicle exceeds a set value over a time period is based on values determined from processed data determined from data obtained from sensors on the vehicle.

5. The method of claim 3, wherein determining the number of times the speed of the vehicle exceeds a set value over a time period is based on location information determined from a locator.

6. The method of claim 5, wherein the locator comprises a GPS receiver.

7. The method of claim 3, further comprising determining the amount of time over which the speed of the vehicle exceeds a set value.

8. The method of claim 7, wherein determining the amount of time over which the speed of the vehicle exceeds a set amount is based on speed and time measurements determined from processed data obtained from sensors on the vehicle.

9. The method of claim 7, wherein determining the amount of time over which the speed of the vehicle exceeds a set amount is based on location information determined using a locator.

10. The method of claim 2, wherein determining the occurrence of events attributable to the modifiable use condition of applying the brakes on the vehicle comprises determining the number of times the vehicle brakes are applied over a set time period.

11. The method of claim 2, wherein determining the occurrence of events attributable to the modifiable use condition of accelerating the vehicle comprises determining the number of times the vehicle accelerates at a rate greater than a set rate over a set time period.

12. The method of claim 2, wherein determining the occurrence of events attributable to the modifiable use condition of decelerating the vehicle comprises determining the number of times the vehicle decelerates at a rate greater than a set rate over a set time period.

13. The method of claim 2, wherein determining the occurrence of events attributable to the modifiable use condition of changing lanes while driving the vehicle comprises determining the number of times the vehicle changes lanes over a set time.

14. The method of claim 13, further comprising determining the number of times the vehicle changes lanes over a set time with or without using turn indicators.

15. The method of claim 2, wherein determining the occurrence of events attributable to the modifiable use condition of driving the vehicle a set distance behind the vehicle ahead of it comprises determining the number of times the vehicle is within a set distance of the vehicle ahead of it.

16. The method of claim 1, further comprising comparing the plurality of use conditions for a plurality of vehicles in the fleet against each other to determine the relative opportunity to reduce the potential for accidents.

17. The method of claim 1, further comprising evaluating the occurrence of events for each of a plurality of modifiable use conditions for each fleet vehicle over time.

18. The method of claim 1, further comprising evaluating the occurrence of events for each of a plurality of modifiable use conditions for a plurality of fleet vehicles over time.

19. The method of claim 1, further comprising adjusting at least one of the use conditions in a vehicle.

20. The method of claim 1, further comprising adjusting at least one of the use conditions for the fleet of vehicles.

21. A system for identifying vehicle safety in a fleet of vehicles comprising:
a computer; and
a data store operably connected to the computer, the data store comprising at least one data set of information concerning the operational condition of the vehicle collected from at least one individual vehicle, and at least one data set of vehicle positioning data collected from the same individual vehicle as the first set of information;
wherein the computer being adapted to calculate the occurrence of events providing at least one opportunity to reduce potential accidents, and to report at least one opportunity to reduce potential accidents.
